(19) United States
(12) Patent Application Publication
(10) Pub. No.: US 2026/0135942 A1
(43) Pub. Date: May 14, 2026

(54) TELEPHONE NUMBER VALIDATION SYSTEM AND METHOD

(71) Applicant: David Kurow, Queen Creek, AZ (US)

(72) Inventor: David Kurow, Queen Creek, AZ (US)

(73) Assignee: PPLCARD, LLC, Chandler, AZ (US)

(21) Appl. No.: 19/279,185

(22) Filed: Jul. 24, 2025

Related U.S. Application Data
(60) Provisional application No. 63/719,794, filed on Nov. 13, 2024.

(51) Int. Cl. H04M 3/42; H04W 12/06

(52) U.S. Cl. CPC H04M 3/42059; H04W 12/06; H04M 2203/6045

(57) ABSTRACT

A method for verifying an identity of a calling party has initiating a call to a called party; and providing a verification code to the called party, the verification code providing information about the calling party.

### TECHNICAL FIELD

The present invention relates to telephonic devices, and, more specifically, to a system and method to validate an identity of a caller in real time.

### BACKGROUND

Recently, there has been an increase in the number of unwanted spam and robocalls. These unwanted calls may be a significant annoyance, disrupting your day and taking up your time. Spam calls may be defined as an incoming call coming from an unverified, suspicious, or known spam/scam telephone number. Many phone companies may label these spam callers to notify and alert phone customers to the potential danger. Robocalls may be defined as automated calls using pre-recorded messages, and may be legal or illegal depending on the content and purpose.

Many spam and robocalls are scams designed to defraud individuals, particularly older adults. Research from Truecaller has found that spam and illegal robocalls may have cost U.S. adults as much as $25 billion each year, with victims losing an average of $452 to scams. The risk posed by spam and scam callers is only likely to worsen as new technologies and tactics make them more difficult to detect. For example, there are many ways to mask spam and robocalls as a legitimate call by “spoofing” the originating number, such that the call appears to a blocking system, as well as called party identities, as coming from a legitimate caller or legitimate source.

Presently, there are devices which may block some unwanted calls. Call blocking prevents unwanted callers from reaching you by intercepting the calls. When a blocked number attempts to call, the call is either immediately sent to voicemail or the phone doesn't ring, and the caller might hear a message indicating the number is unavailable. However, call blocking only works when a telephone number has been identified as to be blocked. Further, as stated above, it is possible to mask spam and robocalls as a legitimate call by “spoofing” the originating number.

A need therefore exists for a system and method to overcome the above issues. The present disclosure satisfies these needs as well as providing other, related advantages as disclosed below.

### SUMMARY

According to an embodiment of the disclosure, a method for verifying an identity of a calling party is disclosed. The method comprises: initiating a call to a called party; and providing a verification code to the called party, the verification code providing information about the calling party.

According to an embodiment of the disclosure, a method for verifying an identity of a calling party is disclosed. The method comprises: registering by a company that employees a calling party with a verification website; registering by the calling party with the verification website, wherein the verification website confirms the calling party is employed by the company; generating a verification code by the verification website when directed by the calling party; initiating a call to a called party; and providing the verification code to the called party, the verification code providing information about the calling party.

According to an embodiment of the disclosure, a method for verifying an identity of a calling party is disclosed. The method comprises: registering by a company that employees a calling party with a verification website; registering by the calling party with the verification website, wherein the verification website confirms the calling party is employed by the company; generating a verification code by the verification website when directed by the calling party; initiating a call to a called party; providing the verification code to the called party after the called party answers; and entering the verification code into the verification website by the called party to display the information of the calling party.

### BRIEF DESCRIPTION OF THE DRAWINGS

The present application is further detailed with respect to the following drawings. These figures are not intended to limit the scope of the present application, but rather, illustrate certain attributes thereof. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The disclosure itself, however, as well as a preferred mode of use and further objectives and advantages thereof, can be best understood by reference to the following detailed description of illustrative embodiments when read in conjunction with the accompanying drawings, wherein:

FIG. 1 is a block diagram of an exemplary telephone number validation system, in accordance with one aspect of the present disclosure;

FIG. 2 is a block diagram of an exemplary computer system/server used in the system depicted in FIG. 1, in accordance with an embodiment of the disclosure;

FIG. 3 shows an exemplary registration page for the system depicted in FIG. 1, in accordance with an embodiment of the disclosure;

FIG. 4 shows an exemplary registration page for the system depicted in FIG. 1, in accordance with an embodiment of the disclosure;

FIG. 5 shows an exemplary registration page for the system depicted in FIG. 1, in accordance with an embodiment of the disclosure;

FIG. 6 shows an exemplary verification page for the system depicted in FIG. 1, in accordance with an embodiment of the disclosure;

FIG. 7 shows an exemplary verification page for the system depicted in FIG. 1, in accordance with an embodiment of the disclosure.

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences may be accomplished by different embodiments that are also intended to be encompassed within the spirit and scope of this disclosure.

The present disclosure provides a system and method for individuals receiving a telephone call to validate an identity of a calling party. While embodiments may be described in connection with telephone, they are non-limiting examples, and the teachings of the present invention apply to any type of telephone phone such as, but not limited to landline telephones, cellular telephones, Voice over Internet Protocol (VoIP) telephones, and similar telephones operating on other communication systems.

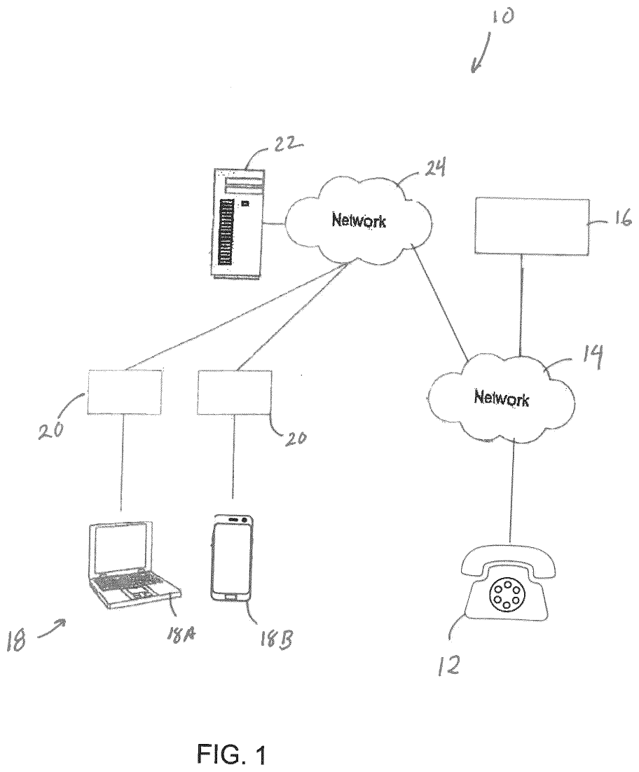

Referring to FIG. 1, a telephone number validation system 10 (hereinafter system 10) may be shown. The components of the system 10 may be coupled by wired or wireless connections. The system 10 may have one or more customer telephones 12. The customer telephone 12 may be a landline telephone, a cellular telephone, a VoIP telephone, or similar type of telephones operating on other communication systems. The customer telephone 12 may be connected to a communication network 14. The communication network 14 may be a Public Switched Telephone Network (PSTN), a cellular wireless network, a VoIP network, or similar communication networks. The customer telephones 12 may receive calls over the communication network 14. These phone calls may be from a third party 16 and may be a warranted or unwarranted call.

Using the system 10, the user of the customer telephone 12 may validate the identity of the third party calling the customer telephone 12. The user of the customer telephone 12 may use a computing device 18. The computing device 18 may be a client computer system such as a desktop computer, handheld or laptop device, tablet, mobile phone device, server computer system, multiprocessor system, microprocessor-based system, network PCs, and distributed cloud computing environments that include any of the above systems or devices, and the like. The computing device 18 may be described in the general context of computer system executable instructions, such as program modules, being executed by a computer system as may be described below. In the embodiment shown in FIG. 1, the computing device 18 may be seen as a desktop/laptop computing system 18A and a mobile phone 18B. However, this should not be seen in a limiting manner as any computing device 18 described above may be used.

The computing device 18 may be loaded with an operating system 20. The operating system 20 of the computing device 18 may manage hardware and software resources of the computing device 18 and provide common services for computer programs running on the computing device 18.

The computing devices 18 may be coupled to a server 22. The computing device 18 may be connected to the server 22 through a network 24. The network 24 may be a local area network (LAN), a general wide area network (WAN), wireless local area network (WLAN) and/or a public network. The server 22 may be used to store data files, programs, and the like for use by the computing device 18. In accordance with one embodiment, the server 22 may be used to host a website and/or programs for interaction with a mobile application for verifying an identity of a calling party as may be described below.

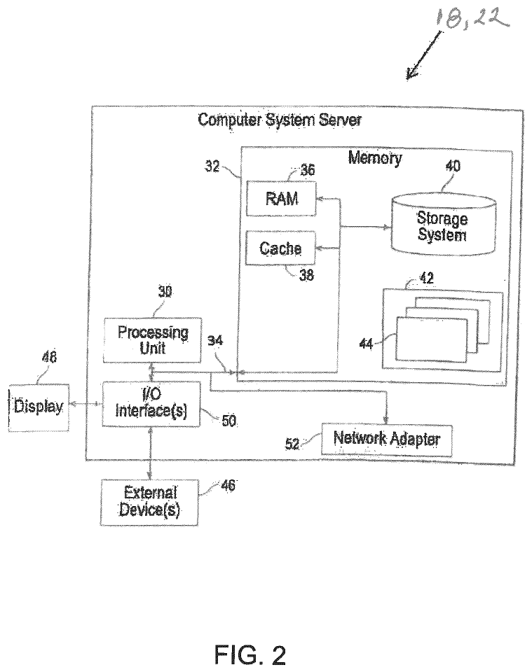

Referring now to FIG. 2, the computing devices 18 and/or server 22 may be described in more detail in terms of the machine elements that provide functionality to the systems and methods disclosed herein. The components of the computing device 18 and/or server 22 may include, but are not limited to, one or more processors or processing units 30, a system memory 32, and a system bus 34 that couples various system components including the system memory 32 to the processor 30. The computing device 18 and/or server 22 may typically include a variety of computer system readable media. Such media may be chosen from any available media, including non-transitory, volatile, and non-volatile media, removable and non-removable media. The system memory 32 may include one or more personal computing system readable media in the form of volatile memory, such as a random-access memory (RAM) 36 and/or a cache memory 38. By way of example only, a storage system 40 may be provided for reading from and writing to a non-removable, non-volatile magnetic media device typically called a “hard drive”.

The system memory 32 may include at least one program product/utility 42 having a set (e.g., at least one) of program modules 44 that may be configured to carry out the functions of embodiments of the invention. The program modules 44 may include, but is not limited to, an operating system, one or more application programs, other program modules, and program data. Each of the operating systems, one or more application programs, other program modules, and program data or some combination thereof, may include an implementation of a networking environment. The program modules 44 generally carry out the functions and/or methodologies of embodiments of the invention as described herein.

The computing device 18 and/or server 22 may communicate with one or more external devices 46 such as a keyboard, a pointing device, a display 48, or any similar devices (e.g., network card, modern, etc.). The display 48 may be a Light Emitting Diode (LED) display, Liquid Crystal Display (LCD) display, Cathode Ray Tube (CRT) display and similar display devices. The external devices 46 may enable the computing device 18 and/or server 22 to communicate with other devices. Such communication may occur via Input/Output (I/O) interfaces 50. Alternatively, the computing device 18 and/or server 22 may communicate with one or more networks 24 such as a local area network (LAN), a general wide area network (WAN), and/or a public network via a network adapter 52. As depicted, the network adapter 52 may communicate with the other components of the computing device 18 and/or server 22 via the bus 34.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, microcode, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media (for example, storage system 40) may be utilized. In the context of this disclosure, a computer readable storage medium may be any tangible or non-transitory medium that can contain, or store a program (for example, the program product 42) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

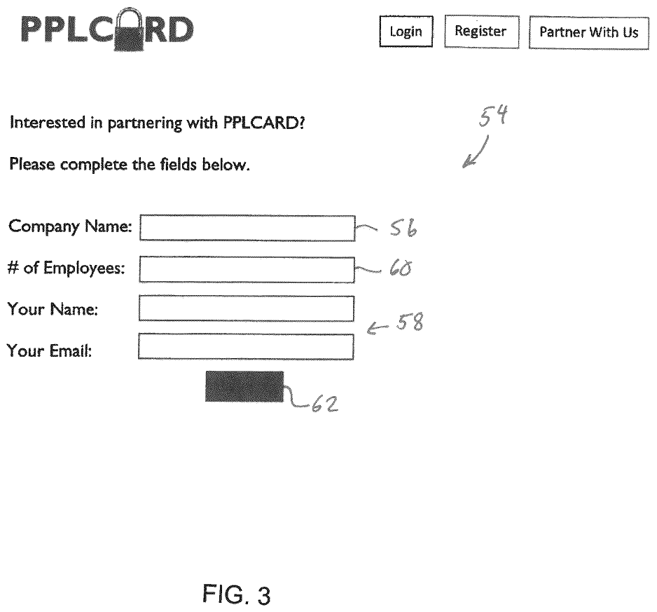

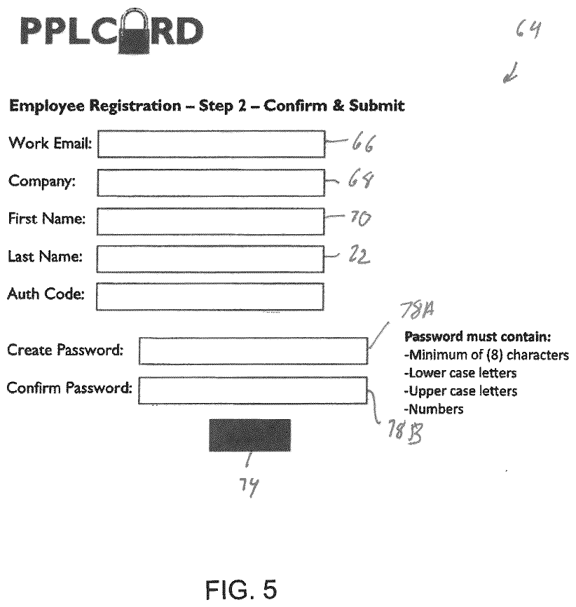

The description below may provide example embodiments in detail. It does not, and is not meant to, limit the invention's application to those details. Referring to the FIGS. 1-6, the operation of system 10 may be described. Any company that may wish to have their employees validated may register with the system 10. The company may go to a company registration webpage 54 as may be shown in FIG. 3. The company registration webpage 54 may have a plurality of different areas for entering information about the company registering. In accordance with the embodiment, shown in FIG. 3, the company registration webpage 54 may have a company name area 56 for entering the name of the company registering, contact area 58 for entering information for the contact person of the company registering, and a size area 60 for entering the number of employees of the company registering. The person entering the above information may then press an enter button 62 to register the company with the system 10.

Once a company has registered, the company may need to upload employee information for all employees who may be registering. This may include but is not limited to first and last name of each employee, work email addresses for each employee, as well as other employment data. Once this information is uploaded to the server 22, personnel of the company may begin to register with the system 10.

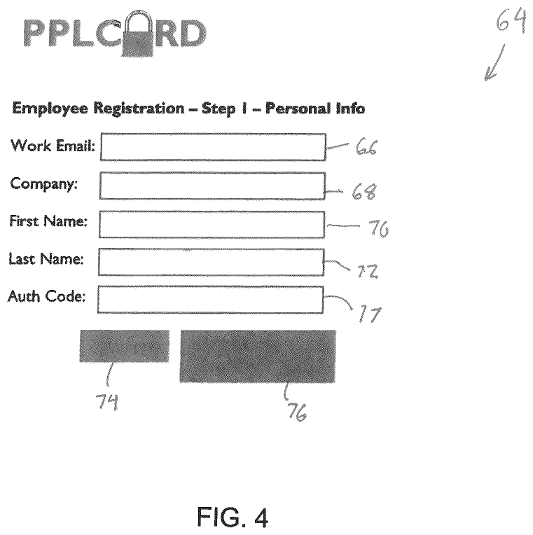

In order for personnel of a company making calls to be validated, the employee must register with the system 10. The employee may access a validation website registration page 64 as may be shown in FIG. 4. The registration page 64 may have a plurality of different areas for entering information related to the personnel. For example, the registration page may have a work email section 66 for entering a work email of the personnel registering, a company name section 68 for entering the company name of where the personnel registering works, a first name section 70 for entering the first name of the personnel registering, and a last name section 72 for entering. In accordance with one embodiment, the company name section 68 may have a pull-down menu listing all companies that are currently registered with the system 10. The personnel may then use the pulldown menu and select the company name who employs the personnel.

Once all the information is entered, the personnel may press an authenticator button 76. Pressing the authenticator button 76 may send the information entered to server 22 for verification. If any information entered is incorrect/not valid, an error message may be shown. For example, if the personnel misspelled an email address, or the name entered does not matched data entered in the server 22, the error message may appear and the personnel may then have to correct the wrongly entered information and resubmit. If all the information entered is correct and verified, the server 22 may generate an authentication code number.

The authentication code number may be sent to the personnel. In accordance with one embodiment may be sent to the email address entered by the personnel. However, the authentication code number may only be sent by the server 22 if the email address has been verified and is stored in the server 22 under the company name associated with the personnel.

The personnel may then enter the authentication code into the authentication code area 77 and push the enter button 74. If the verification code is correct, the personnel may have to create a password as may be shown in FIG. 4. A create password section 78A and a confirm password section 78b may be displayed and the personnel may have to create and enter a password. In accordance with one embodiment, the password may need to be a certain length and may require one or more of a capital letter, a lower case letter and/or a special character. Once the password is created, the personnel may press the enter button 74 to see if the password is accepted. Once the password is accepted, the personnel may be registered and may use the system 10 and called individuals may verify the identity of the personnel calling.

Prior to making any telephone calls, the personnel may log into the system 10. The personnel may press an authenticator button 78 so that the server 22 may generate an authentication code number that may be sent to the personnel. The authentication code number may then be given out to individuals being called for verification purposes.

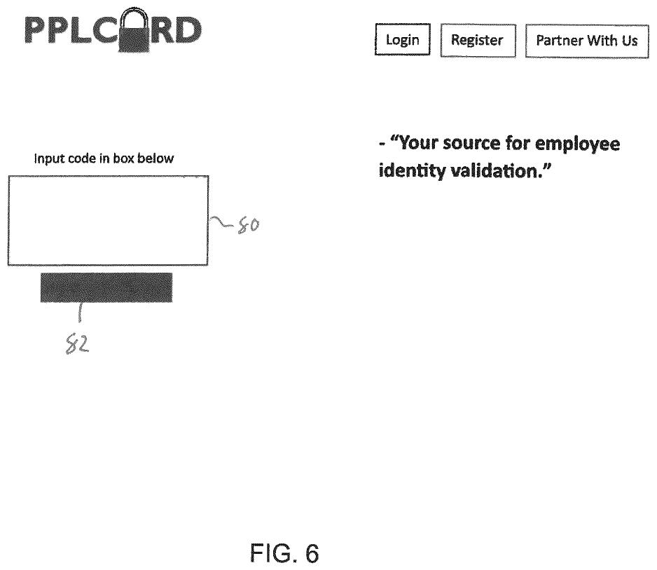

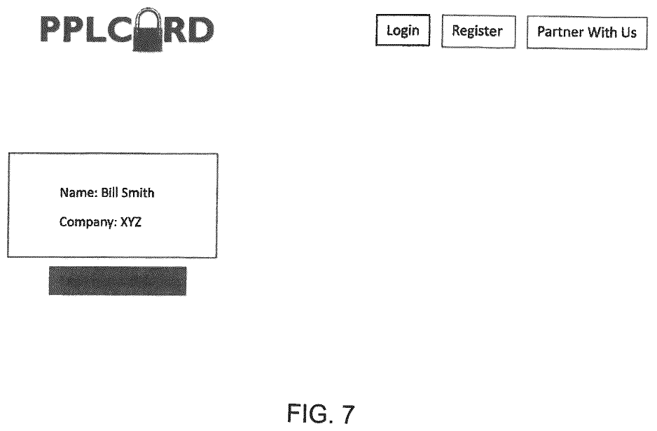

Once logged in, the personnel may call an individual on the customer telephone 12 for a business reason associated with the company where the personnel may work. When the telephone call is placed, the individual answering the customer telephone 12 may be skeptical of the telephone call even is the caller identification may show the company where the personnel may work. In this situation, the personnel may let the individual answering the customer telephone 12 that the personnel works for the XYZ company and that the individual may verify this information by going to the authentication website hosted on the server 22. Alternatively, or in addition to, the personnel may have the individual open up a verification app on a mobile device. As may be shown in FIG. 6, once the individual has gone to the authentication website or the verification app on a mobile device, the personnel may provide the authentication code to the individual. The individual may enter the authentication code into an authentication area 80. Once entered, the individual may press an enter button 82. Details of the calling party may then be displayed as may be shown in FIG. 7. For example, once the individual enters the authentication code, the authentication website or the verification app may display that the personnel calling is John Smith who works for the XYZ Company. Once the individual verifies that the personnel is who they claim to be and does work for the specified company, the individual may feel more comfortable that the telephone call is legitimate.

The foregoing description is illustrative of particular embodiments of the invention but is not meant to be a limitation on the practice thereof. While embodiments of the disclosure have been described in terms of various specific embodiments, those skilled in the art will recognize that the embodiments of the disclosure may be practiced with modifications without departing from the spirit and scope of the invention.

1. A method for verifying an identity of a calling party comprising:
initiating a call to a called party; and
providing a verification code to the called party, the verification code providing information about the calling party.

2. The method of claim 1, comprising entering the verification code into a verification website by the called party to display the information of the calling party.

3. The method of claim 1, comprising:
opening a verification website on a computer system by the called party; and
entering the verification code into the verification website by the called party to display the information of the calling party.

4. The method of claim 1, comprising:
opening a verification application on a mobile device by the called party; and
entering the verification code into the verification application by the called party to display the information of the calling party.

5. The method of claim 1, comprising generating a verification code for the calling party from a verification website to provide to the called party.

6. The method of claim 1, comprising:
registering by a company that employees the calling party with a verification website; and
registering by the calling party with the verification website, wherein the verification website confirms the calling party is employed by the company.

7. The method of claim 1, comprising:
registering by a company that employees the calling party with a verification website;
providing a list of personnel employed by the company to the verification website; and
registering by the calling party with the verification website, wherein the verification website confirms the calling party is employed by the company.

8. A method for verifying an identity of a calling party comprising:
registering by a company that employees a calling party with a verification website;
registering by the calling party with the verification website, wherein the verification website confirms the calling party is employed by the company;
generating a verification code by the verification website when directed by the calling party;
initiating a call to a called party; and
providing the verification code to the called party, the verification code providing information about the calling party.

9. The method of claim 8, comprising entering the verification code into a verification website by the called party to display the information of the calling party.

10. The method of claim 8, comprising:
opening the verification website on a computer system by the called party; and
entering the verification code into the verification website by the called party to display the information of the calling party.

11. The method of claim 8, comprising:
opening a verification application on a mobile device by the called party;
entering the verification code into the verification application by the called party; and
displaying the information of the calling party.

12. The method of claim 8, comprising comparing information provided by the calling party to information entered by the company to verify the calling party is employed by the company.

13. A method for verifying an identity of a calling party comprising:
registering by a company that employees a calling party with a verification website;
registering by the calling party with the verification website, wherein the verification website confirms the calling party is employed by the company;
generating a verification code by the verification website when directed by the calling party;
initiating a call to a called party;
providing the verification code to the called party after the called party answers; and
entering the verification code into the verification website by the called party to display the information of the calling party.

14. The method of claim 13, comprising:
opening the verification website on a computer system by the called party; and
entering the verification code into the verification website by the called party to display the information of the calling party.

15. The method of claim 13, comprising:
opening a verification application on a mobile device by the called party;
entering the verification code into the verification application by the called party; and
displaying the information of the calling party.
